(19) United States
(12) Patent Application Publication
(10) Pub. No.: US 2009/0040358 A1
(43) Pub. Date: Feb. 12, 2009

(54) IMAGE-RECORDING DEVICE AND METHOD OF CONTROLLING OPENING AND CLOSING OF LENS BARRIER OF SAME

(76) Inventors: Masataka OTA, Fujisawa (JP); Toshihiko Ono, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/164,403

(22) Filed: Jun. 30, 2008

(30) Foreign Application Priority Data
Aug. 9, 2007 (JP) 2007-208602

(51) Int. Cl. H04N 5/225

(52) U.S. Cl. 348/335; 348/E05.024

(57) ABSTRACT

An object of the present invention is to reduce the time an image-recording device takes for switching from power-saving mode to recording-mode.

An image-recording device comprises a lens; a lens barrier protecting the lens; a lens opening/closing controller for controlling the lens barrier to open and close; and a controller, wherein the controller controls the image-recording device to switch from recording-mode, in which the lens barrier is opened by the lens barrier opening/closing controller and the image-recording device records an image using the lens, to power-saving mode, in which the image-recording device stops taking the image in the recording mode in accordance with a predetermined instruction and conducts processing for saving power, and controls the lens barrier to maintain open-state in power-saving mode.

### CROSS-REFERENCE TO RELATED APPLICATIONS

This application relates to and claims priority from Japanese Patent Application No. 2007-208602, filed on Aug. 9, 2007, the entire disclosure of which is incorporated herein by reference.

### BACKGROUND

1. Field of the Invention

The invention relates generally to an image-recording device and a method of controlling the opening and closing of a lens barrier of an image-recording device, and in particular, is suitable for application in an image-recording device provided with a lens barrier and a power-saving mode for saving power consumption.

2. Description of Related Art

As an image-recording device, for example, a video camera provided with a lens barrier is known. The invention disclosed in JP2007-60304 A, which has been known as a technique of controlling opening and closing of the lens barrier of a video camera, includes a rotational movement detector detecting the position of the rotational movement of a display housing having a display; and a main controller controlling a lens barrier opening/closing controller of a video camera based on the position of the rotational movement of the display housing detected by the rotational movement detector, wherein a main controller controls the lens barrier to switch to a “closed” state when the display housing is positioned in a stow-away position opposed to a main plane of the main body, and controls the lens barrier to switch to an “open” state when the display housing is moved to a position rotated from the stow-away position, so that the video camera can immediately switch to recording-mode with a simple procedure.

There is also a known video camera which is designed to reduce power consumption. In the video camera, when, for example, a user presses a predetermined button; the video camera supplies power to a selected circuit in the video camera; stops power supply to circuits other than the selected circuit; and thereby switches to power-saving mode while reducing power consumption.

### SUMMARY

In the video camera having a lens barrier, the lens barrier will be in a “closed” state to protect the lens because the video camera does not record an image when in power-saving mode.

Accordingly, when the video camera is switched from a power-saving mode to a recording-mode, the video camera needs to control the lens barrier to switch from a “closed” state to “open” state, but it takes time to switch from the power-saving mode to the recording-mode, and as a result, there is a problem in that a user has to wait longer before being able to start recording.

The technique disclosed in JP2007-60304 A can immediately switch the video camera to recording-mode with a simple procedure. However, the technique has not been devised in consideration of reducing the time it takes for the video camera to control the lens barrier to open/close when the video camera switches from the power-saving mode to the recording-mode.

The present invention has been devised in consideration of the above-described points, and it is an object of the present invention to provide an image-recording device and a method of controlling the opening and closing of a lens barrier of an image-recording device capable of reducing the time to switch from a power-saving mode to a recording-mode.

According to an aspect of the invention, an image-recording device comprises a lens, a lens barrier protecting the lens, a lens opening/closing controller for controlling the lens barrier to open and close, and a controller for controlling the image-recording device to switch from recording-mode, in which the lens barrier is opened by the lens barrier opening/closing controller and the image-recording device records an image using the lens, to power-saving mode, in which the image-recording device stops taking the image in the recording mode in accordance with a predetermined instruction and conducts processing for saving power, and controlling the lens barrier to maintain the “open” state in power-saving mode.

According to the present invention, an image-recording device and a method of controlling the opening and closing of a lens barrier of an image-recording device capable of reducing the time to switch from a power-saving mode to a recording-mode can be provided.

Other aspects and advantages of the invention will be apparent from the following description and the appended claims.

### BRIEF DESCRIPTION OF THE DRAWINGS

FIG. 1 is a diagram showing the front view of an image-recording device according to the invention.

FIG. 2 is a diagram showing the lens barrier of an image-recording device in an “open” state according to the invention.

FIG. 3 is a diagram showing the rear view of an image-recording device according to the invention.

FIG. 4 is a diagram showing an operation unit according to the invention.

FIG. 5 is a schematic block diagram showing the outline of the internal configuration of an image-recording device according to the invention.

FIG. 6 is a diagram showing a part of the configuration of a controller according to the invention.

FIG. 7 is a flowchart illustrating lens barrier opening and closing processing according to the invention.

### DETAILED DESCRIPTION OF THE PREFERRED EMBODIMENTS

An embodiment of the present invention will be described below with reference to the attached drawings. It should be understood that the present invention is not limited to this embodiment. Incidentally, the below embodiment will be described for the situation where an image-recording device according to the invention is applied to a video camera 1. Furthermore, the invention relates to controlling the opening and closing of a lens barrier of an image-recording device, so the detailed descriptions of the configuration of members not relating to controlling the opening and closing will be omitted in the below embodiment.

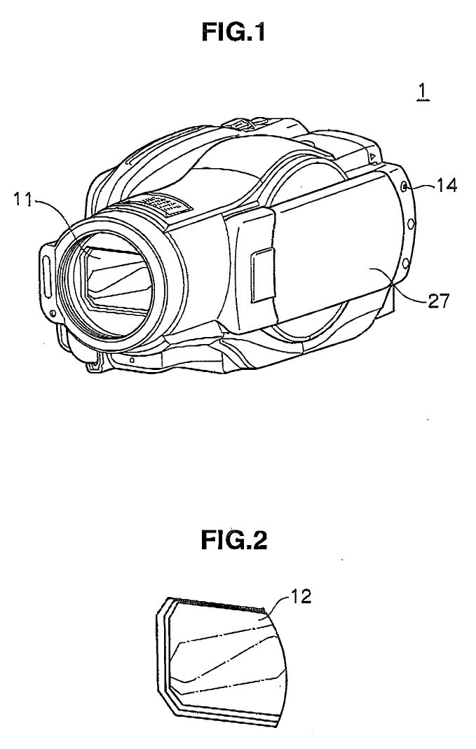

FIG. 1 is a diagram showing the front view of the video camera 1. As shown in FIG. 17 the video camera 1 includes a lens barrier 11, a power-saving mode button 14 and display housing 27. The lens barrier 11 is designed to protect a lens, which will be described later below, located in a lens-barrel unit of the video camera 1. FIG. 2 is a diagram showing an “open” state 12 of the lens barrier 11 of the video camera 1.

The power-saving mode button 14 allows the video camera 1 to switch from a recording-mode, in which the video camera can record an image, to a power-saving mode; or to switch from the power-saving mode to the recording-mode. A power-saving mode is a mode for reducing a power consumption as well as for speeding up the activation of the video camera 1 by supplying a power only to selected units in the video camera.

The display housing 27 is provided with a display, which will be described later below, arranged at a face where the display housing 27 is in contact with the main body of the video camera 1; and is capable of opening and closing by a supporting member provided at the front end side of the video camera 1.

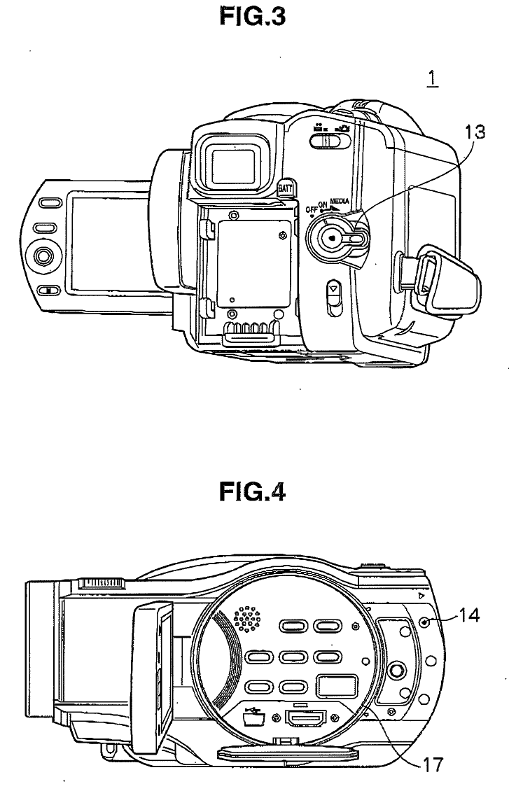

FIG. 3 is a diagram showing a rear view of the video camera 1. As shown in FIG. 3, a power on/off switch 13 is provided on the rear of the video camera 1. The power on/off switch 13 is a switch used for directing the video camera 1 to deliver power. A user instructs the video camera to power on (“ON”) or power off (“OFF”) by rotating the power on/off switch 13.

FIG. 4 is a diagram showing an operation unit 17, and showing the side view of the video camera 1 with the display housing 27 in an “open” state. The operation unit 17 is provided with more than one button for operating the video camera 1. These buttons are for a user to conduct operations such as those for guide, backlight control, exposure, focus, screen display, and finalizing.

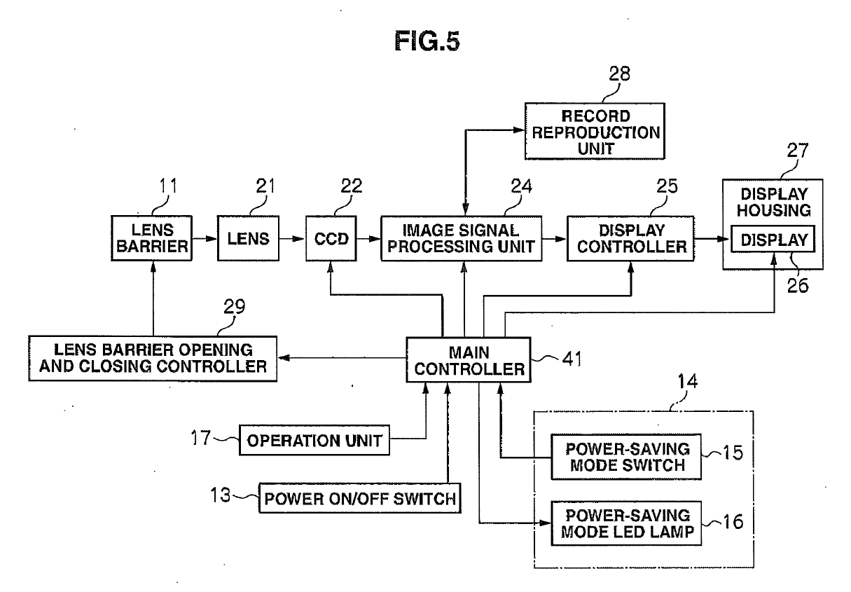

FIG. 5 is a schematic block diagram showing the outline of the internal configuration of the video camera 1. In addition to the above-described power switch 13, power-saving mode button 14 and operation unit 17, the video camera includes a lens 21; an image sensor 22; a lens barrier 11; an image signal processing unit 24; a display controller 25; a display 26; a display housing 27; a record reproduction unit 28; a lens barrier opening/closing controller 29; and a main controller 41.

Also, the above-described power-saving mode button 14 consists of a power-saving mode switch 15 and a power-saving mode LED lamp 16 in an integrated manner. The power-saving mode switch 15 is a switch which allows the video camera 1 to switch from a recording-mode, in which the video camera can record an image, to a power-saving mode; or to switch from the power-saving mode to the recording-mode. The power-saving mode LED lamp 16 is a lamp that emits light when the video camera 1 is in the power-saving mode. A user can recognize whether or not the video camera 1 is in the power-saving mode depending on whether or not the power-saving mode LED lamp 16 is emitting light or not.

The lens barrier 11 is arranged at the fore region of the lens 21 in a light axial direction in a position in which the lens barrier 11 can open and close. The image sensor 22 converts a light signal coming in via the lens 21 to an electrical signal and outputs the signal. The image signal processing unit 24 generates an image signal based on the electrical signal output from the image sensor 22, and executes various signal processing, such as a noise reduction, image-quality adjustment, and image compression, on the image signal. The display controller 25 controls the display 26 to display an image signal output from the image signal processing unit 26. The display 26 is provided in the display housing 27, and is capable of displaying an image signal based on the control from the display controller 25. The record reproduction unit 28 allows an image signal output from the image signal processing unit 24 to be recorded on a information medium, such as a hard disk drive, a disk drive, or a semiconductor memory card. The lens barrier opening/closing controller 29 controls the lens barrier 11 to open/close based on the control from the main controller 41.

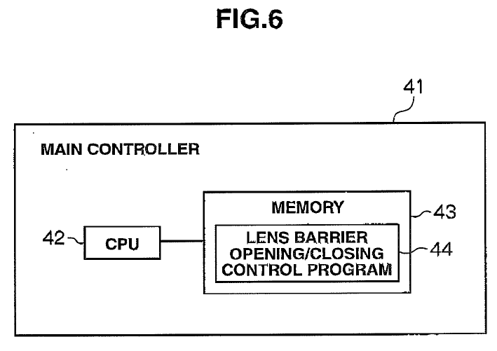

The main controller 41 controls the entire system of the video camera 1. FIG. 6 is a diagram showing a part of the configuration of the main controller 41. As shown in FIG. 6, the main controller 41 includes a CPU 42 and memory 43. A lens barrier opening and closing control program 44 is stored in the memory 43. The CPU 42 implements the opening and closing of the lens barrier 11 according to the invention by executing the lens barrier opening and closing control program 44 stored in the memory 43.

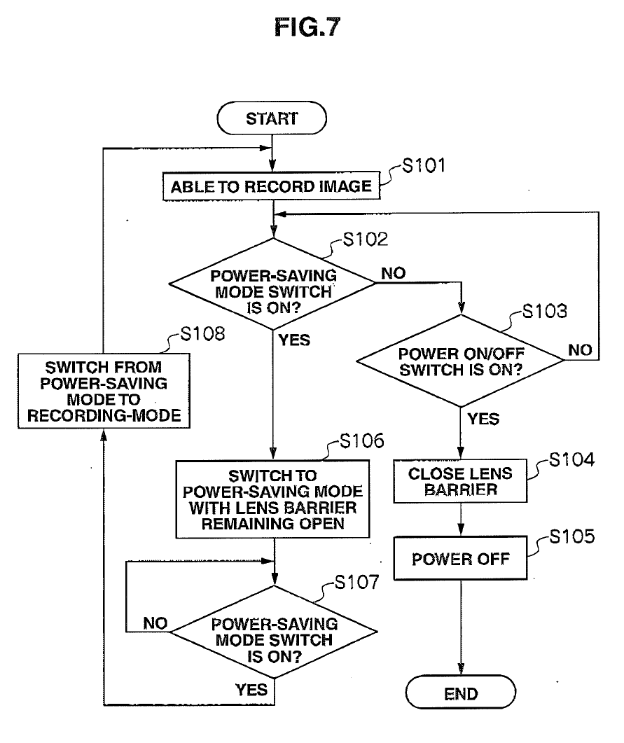

Next, lens barrier opening and closing processing when the main controller 41 executes the lens barrier opening and closing control program 44 will be described. FIG. 7 is a flowchart illustrating the lens barrier opening and closing processing. This lens barrier opening and closing processing is executed when a user activates the power on/off switch 13 and the power of the video camera 1 is in an “ON” state, i.e., the video camera 1 can record an image. When the video camera can record an image, the lens barrier 11 is naturally in the “open” state 12, as shown in FIG. 2.

When the video camera 1 can record an image, i.e. recording-mode (SI 01), the main controller 41 determines whether or not the power-saving mode switch 15 is “ON” based on a signal sent from the power-saving mode switch 15 (S102). In step S102, if the power-saving mode switch 15 is not “ON” (S102: NO), the main controller 41 determines whether or not the power on/off switch 13 is “OFF” based on a signal sent from the power on/off switch 13 (S103). Instep S103, if the power on/off switch 13 is not “OFF” (S103: NO), the main controller 41 executes the processing in step S102 again. More specifically, during the period in which the video camera 1 is in recording-mode, the main controller 41 monitors signals sent from the power-saving mode switch 15 and the power on/off switch 13.

In step S103, if the power on/off switch 13 is “OFF” (S103: YES), the main controller 41 directs the lens barrier opening/closing controller 29 to close the lens barrier 11 in step S104. Thus, the lens barrier opening/closing controller 29 conducts the control for closing the lens barrier 11, and the lens barrier is turned to a “closed” state. Then in step S105, the main controller 41 turns “OFF” the power to the video camera 1.

Meanwhile, in step S102, if the main controller 41 determines that the power-saving mode switch 15 is “ON” (S102: YES), the main controller 41 switches the video camera 1 to power-saving mode with the lens barrier 11 remaining open (S106). Thus, a power is supplied only to some of the units in the video camera 1—for example units which take time to start-up a hard disk drive, etc.—so that electrical power can be saved.

In step S107, the main controller 41 determines whether or not the power-saving mode switch 15 is turned “ON”. More specifically, the main controller 41 determines whether or not the power-saving mode button 14 is pressed by the user when the video camera 1 is in power-saving mode. If the main controller 41 determines that the power-saving mode switch 15 is not turned “ON” (S107: NO), the main controller 41 monitors signals sent from the power-saving mode switch 15 until it is determined that the power-saving mode switch 15 is turned “ON.”

If the main controller 41 determines that the power-saving mode switch 15 is turned “ON” (S107: YES), the main controller 41 executes processing for switching the video camera 1 from power-saving mode to recording-mode in step S108. Thus, power is supplied to the units in the video camera 1, and the video camera 1 will be able to record an image again (S101).

According to the video camera 1 in this embodiment, the video camera 1 can quickly switch from power-saving mode to recording-mode without controlling the lens barrier 11 to switch from “closed” state to “open” state since the lens barrier 11 is in “open” state when the video camera 1 is in power-saving mode, so the time the video camera 1 takes before being able to start recording an image can be reduced.

The above embodiment is described with reference to the configuration in which the power-saving mode LED lamp 16 is provided with the video camera 1 and a user is informed of the video camera 1 being in power-saving mode by means of the power-saving mode LED lamp 16, however, the video camera 1 may be configured without including the power-saving mode LED lamp 16. That is because the video camera 1 can inform a user of the video camera 1 being able to record an image, since the video camera 1 can record an image when the lens barrier 11 is in “open” state; or because the video camera 1 can quickly inform a user of the video camera 1 being able to record an image by means of the power-saving mode button 14. In other words, the video camera 1 can be configured without including the power-saving mode LED lamp 16, since the video camera 1 can inform a user of the video camera 1 being able to record an image when the lens barrier 11 is in “open” state.

Furthermore, in this embodiment, the invention has been described for the situation where the present invention is utilized in the video camera 1 provided with the lens 21; the lens barrier 11 protecting the lens 21; the lens barrier opening/closing controller 29 controlling the opening and closing of the lens barrier 11, and the main controller 41, wherein the main controller 41 controls the video camera 1 to switch from recording-mode, in which the lens barrier opening/closing controller 29 switches the lens barrier 11 to the “open” state and the video camera 1 records an image by the lens 21, to power-saving mode, in which the video camera 1 stops recording the image in the recording mode in accordance with a predetermined instruction and conducts power-saving processing; and controls the lens barrier to maintain the “open” state in power-saving mode. However, the present invention in not limited to this embodiment, and can also be utilized in an image-recording device having a lens barrier.

Moreover, the present invention is described for the situation where the video camera 1 is provided with a power-saving mode button 14 for instructing the video camera 1 to switch to power-saving mode, and the main controller 41 switches the video camera 1 from recording-mode to power-saving mode when the power-saving mode button 14 is pressed by a user. However, the trigger for those mode-switches is not limited to the time when the power-saving mode button 14 is pressed by a user.

The present invention can be broadly utilized in an image-recording device having a lens barrier and a method of controlling the opening and closing of a lens barrier of an image-recording device.

While the invention has been described with respect to a limited number of embodiments, those skilled in the art, having benefit of this disclosure, will appreciate that other embodiments can be devised that do not depart from the scope of the invention as disclosed herein. Accordingly, the scope of the invention should be limited only by the attached claims.

What is claimed is:

1. An image-recording device comprising:
a lens,
a lens barrier protecting the lens,
a lens opening/closing controller for controlling the lens barrier to open/close, and
a controller, wherein
the controller controls the image-recording device to switch from recording-mode, in which the lens barrier opening/closing controller switches the lens barrier to open-state and the image-recording device records an image by using the lens, to power-saving mode, in which the image-recording device stops recording the image in the recording mode in accordance with a predetermined instruction and conducts processing for saving power; and controls the lens barrier to maintain open-state in power-saving mode.

2. The image-recording device according to claim 1, further comprising;
an input unit for inputting the predetermined instruction, wherein
the controller controls the image-recording device to switch from the recording-mode to the power-saving mode when the predetermined instruction is input to the input unit.

3. The image-recording device according to claim 2, wherein:
when the predetermined instruction is input to the input unit again in the power-saving mode, the controller controls the image-recording device to switch from the power-saving mode to the recording-mode.

4. A method of controlling opening and closing of a lens barrier of an image-recording device having a lens, a lens barrier protecting the lens, and a lens opening/closing controller controlling the lens barrier to open and close, comprising:
a step of controlling the image-recording device to switch from recording-mode, in which the lens barrier is opened by the lens barrier opening/closing controller and the image-recording device records an image by using the lens, to power-saving mode, in which the image-recording device stops taking the image in the recording mode in accordance with a predetermined instruction and conducts processing for saving power; and controlling the lens barrier to maintain open-state in power-saving mode.

5. The method of controlling opening and closing of a lens barrier of an image-recording device according to claim 4, wherein:
in the step of controlling the image-recording device, the image-recording device is controlled to switch from the recording-mode to the power-saving mode when the predetermined instruction is input to an input unit.

6. The method of controlling opening and closing of a lens barrier of an image-recording device according to claim 5, wherein:
in the step of controlling the image-recording device, when the predetermined instruction is input to the input unit again in the power-saving mode, the image-recording device is controlled to switch from the power-saving mode to recording-mode.
